(19) United States
(12) Patent Application Publication
(10) Pub. No.: US 2026/0204746 A1
(43) Pub. Date: Jul. 16, 2026

(54) BATTERY CELL

(71) Applicant: SK On Co., Ltd., Seoul (KR)

(72) Inventors: Seung Ho KWAK, Daejeon (KR); Soo Min PARK, Daejeon (KR)

(21) Appl. No.: 19/449,424

(22) Filed: Jan. 15, 2026

(30) Foreign Application Priority Data
Jan. 15, 2025 (KR) 10-2025-0006239
Aug. 4, 2025 (KR) 10-2025-0106700

(51) Int. Cl. H01M 50/533; H01M 50/103; H01M 50/15; H01M 50/188; H01M 50/46; H01M 50/548

(52) U.S. Cl. CPC H01M 50/533; H01M 50/103; H01M 50/15; H01M 50/188; H01M 50/46; H01M 50/548

(57) ABSTRACT

A battery cell may include: a case including a receiving space receiving an electrode assembly and a current collector, and one or more openings extended to the receiving space and corresponding to the current collector; and one or more cap assemblies including a cap plate coupled to the opening, an insulating member including an insertion hole into which the projection is inserted, and a terminal electrically connected to the projection inserted into the insertion hole, wherein the insulating member and the cap plate may be integrated by insert injection.

### CROSS-REFERENCE TO RELATED PATENT APPLICATION

The present application claims priority under 35 U.S.C. § 119(a) to Korean patent application number 10-2025-0006239 filed on January 15, 2025 and Korean patent application number 10-2025-0106700 filed on August 4, 2025, in the Ministry of Intellectual Property, the entire disclosure of which is incorporated by reference herein.

### BACKGROUND OF THE INVENTION

### 1. Field

The present disclosure relates to a battery cell.

### 2. Description of the Related Art

A battery cell can convert chemical energy into electrical energy using an oxidation-reduction reaction. Such a battery cell may be used to manufacture a battery pack. For example, the battery pack may include a plurality of battery cells. The battery cell (or a battery pack including the battery cells) may be used as a power source for various devices (e.g., electronic devices, electric vehicles, and/or energy storage devices).

### SUMMARY OF THE INVENTION

According to one aspect of the present disclosure, a battery cell with improved reliability may be provided.

In an embodiment, the present disclosure may be widely applied in the fields of electric vehicles, battery charging stations, energy storage systems (ESS), and other green technologies such as photovoltaics and wind power utilizing batteries. In addition, this disclosure may be used for eco-friendly mobility, including electric vehicles and hybrid vehicles to prevent climate change by curbing air pollution and greenhouse gas emissions.

A battery cell according to the present disclosure may include: a case including a receiving space receiving the electrode assembly and the current collector, and one or more openings extended to the receiving space and corresponding to the current collector; and one or more cap assemblies including a cap plate coupled to the opening, an insulating member including an insertion hole into which the projection is inserted, and a terminal electrically connected to the projection inserted into the insertion hole. The insulating member and the cap plate may be integrated by insert injection.

In an embodiment, the insulating member may include a first support disposed on a first surface of the cap plate adjacent to the electrode assembly, a second support disposed on a second surface of the cap plate, and a connection disposed between the first support and the second support to penetrate the cap plate.

In an embodiment, the first support, the second support, and the connection may be integrated.

In an embodiment, the cap plate may include a through-hole through the cap plate. The connection may be disposed within the through-hole and have a shape corresponding to the through-hole.

In an embodiment, the through-hole may include a first through-hole and a second through-hole spaced apart from the first through-hole. The connection may include a first connection disposed within the first through-hole, and a second connection disposed within the second through-hole.

In an embodiment, a diameter of the first through-hole may be different from a diameter of the second through-hole.

In an embodiment, the insertion hole may penetrate the first connection.

In an embodiment, a diameter of the insertion hole may be smaller than the diameter of the first through-hole.

In an embodiment, a plurality of second through-holes may be provided. The plurality of second connections may be provided to correspond to each of the second through-holes.

In an embodiment, the second support may include a flat portion disposed on the second surface of the cap plate, and a bend bent from an edge of the flat portion to form a receiving groove within a space from the flat portion.

In an embodiment, the terminal may include an edge inserted into the receiving groove, and a center surrounded by the edge.

In an embodiment, a first direction may be defined, which is a direction from the first support toward the second support. A thickness of the edge in the first direction may be less than a thickness of the center in the first direction.

In an embodiment, the insertion hole may expose a surface of the terminal. The projection inserted into the insertion hole may be electrically connected to the surface of the terminal.

In an embodiment, the insertion hole may further penetrate the terminal. In an embodiment, at least a portion of the projection inserted into the insertion hole may be exposed outwardly of the terminal.

In an embodiment, the cap plate may include a recess recessed from the second surface of the cap plate to the first surface of the cap plate. The second support may be disposed within the recess.

In an embodiment, a plurality of electrode assemblies may be provided. Each of the electrode assemblies may include a first electrode tab and a second electrode tab withdrawn in opposite direction from each other. The current collector includes a projection electrically connected to the electrode assembly. The plurality of electrode assemblies may be stacked such that the first electrode tab and the second electrode tab are aligned with each other, respectively, to form an electrode assembly stack. The current collector may be provided on a first surface and a second surface of the electrode assembly stack, respectively. The first electrode tab and the second electrode tab may be bent to surround the current collector in a direction toward the projection.

In an embodiment, the first electrode tab may include a first electrode extension extending from a first surface of the electrode assembly stack, and a first electrode bend bent from the first electrode extension and electrically connected to the current collector. The second electrode tab may have a shape symmetrical to the first electrode tab with the electrode assembly stack interposed therebetween.

In an embodiment, in an overlapping area where the first electrode bend and the current collector overlap, a thickness of the current collector may be greater than a thickness of the first electrode bend.

In an embodiment, in the overlapping area, a thickness of the current collector may taper in a direction toward the projection.

In an embodiment, a roughness of a first surface of the current collector adjacent to the electrode assembly stack may be greater than a roughness of a second surface opposite the first surface of the current collector.

According to an embodiment of the present disclosure, the reliability of a battery cell may be improved.

### BRIEF DESCRIPTION OF THE DRAWINGS

FIG. 1 is a perspective view to illustrate a battery cell according to the present disclosure.

FIG. 2 is an exploded view to illustrate an electrode assembly stack, a current collector, and a cap assembly included in a battery cell according to the present disclosure.

FIG. 3 is a perspective view to illustrate a case included in a battery cell according to the present disclosure.

FIG. 4 is a diagram to illustrate the electrical connection of a first electrode tab and a current collector.

FIG. 5 is a diagram to illustrate a first electrode tab electrically connected to a current collector.

FIG. 6 is a cross-sectional view to illustrate an embodiment of a cross-section cut along the line I1-I2 of FIG. 5.

FIG. 7 is a cross-sectional view to illustrate another embodiment of a cross-section cut along the line I1-I2 of FIG. 5.

FIG. 8 is a diagram to illustrate the coupling of a cap assembly with a current collector.

FIG. 9 is plan views to illustrate a cap plate, an insulating member, and a terminal included in a cap assembly.

FIG. 10 is diagrams to illustrate a cross-section of a cap plate, a cross-section of an insulating member, and a cross-section of a terminal included in a cap assembly.

FIG. 11 is a schematic cross-sectional view of a battery cell to illustrate a state in which a projection is inserted into an insertion hole.

FIG. 12 is a schematic cross-sectional view illustrating a modified embodiment of FIG. 11.

### DETAILED DESCRIPTION

Hereinafter, the present disclosure will be described in detail with reference to the accompanying drawings. However, this is merely illustrative, and the present disclosure is not limited to the specific embodiments described by way of example.

In the present disclosure, first to third directions DR1, DR2, DR3 are defined.

The first direction DR1 may be a direction in which first electrode tabs 111, 121 of electrode assembly stacks 110, 120 protrude. The second direction DR2 may be a direction intersecting (or perpendicular to) the first direction DR1. The second direction DR2 may be a direction in which a first electrode assembly 110 and a second electrode assembly 120 are stacked. The third direction DR3 may be a direction intersecting (or perpendicular to) each of the first direction DR1 and the second direction DR2. The third direction DR3 may be opposite to the direction of gravity and may be referred to as the "height direction".

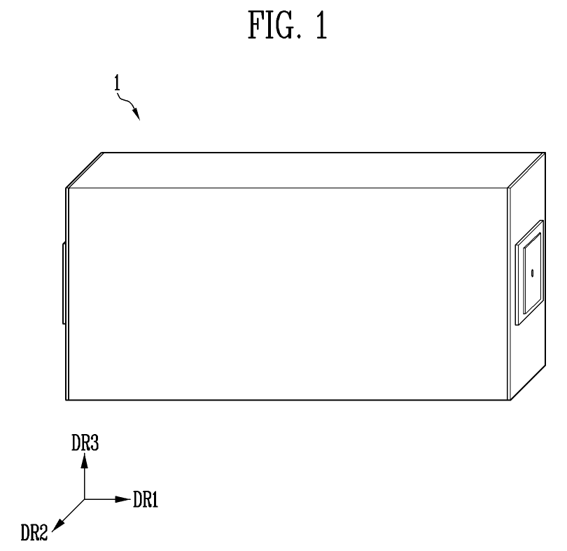

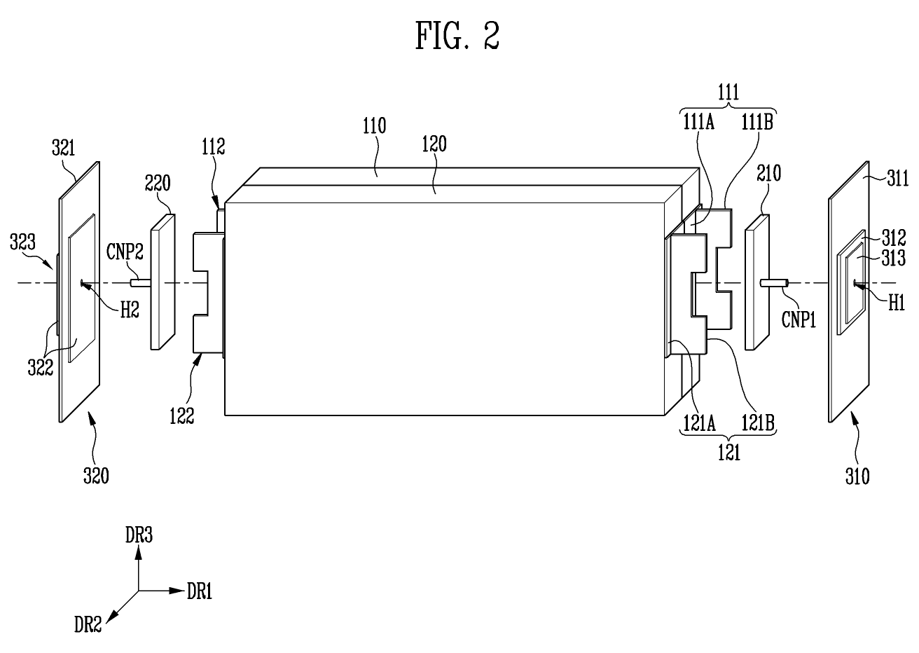

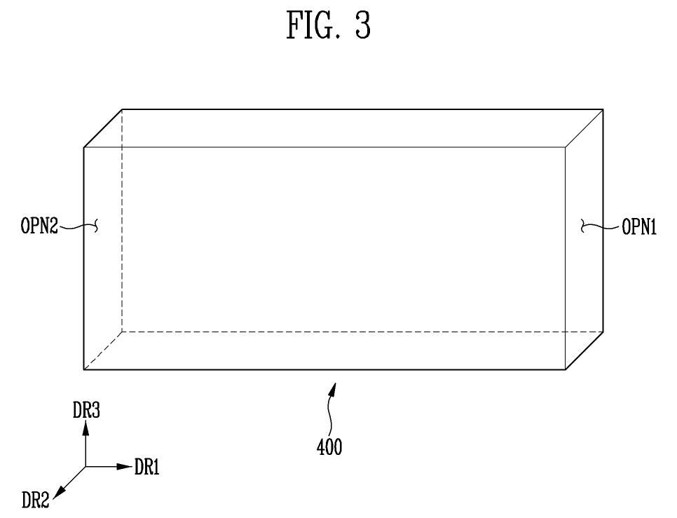

FIG. 1 is a perspective view to illustrate a battery cell according to the present disclosure. FIG. 2 is an exploded view to illustrate an electrode assembly stack, a current collector, and a cap assembly included in a battery cell according to the present disclosure. FIG. 3 is a perspective view to illustrate a case included in the battery cell according to the present disclosure.

Referring to FIGS. 1 to 3, a battery cell 1 may include electrode assembly stacks 110, 120, a first current collector 210, a second current collector 220, a first cap assembly 310, a second cap assembly 320, and a case 400.

The electrode assembly stacks 110, 120 may include one or more electrode assemblies. For example, the electrode assembly stacks 110, 120 may include a first electrode assembly 110 and a second electrode assembly 120. However, the present disclosure is not limited thereto. For example, the electrode assembly stacks 110, 120 may include three or more electrode assemblies. For ease of description, the description will be set forth on an embodiment in which the electrode assembly stacks 110, 120 include the first electrode assembly 110 and the second electrode assembly 120.

The first electrode assembly 110 may have a wound structure in which a negative electrode, a positive electrode, and a separator are wound. However, the present disclosure is not limited thereto. For example, the first electrode assembly 110 may have a stacking shape, a zigzag-folding shape, or a stack-folding shape.

The first electrode assembly 110 may include a first negative electrode tab 111 and a first positive electrode tab 112.

The first negative electrode tab 111 may be provided on a first surface of the first electrode assembly 110. The first negative electrode tab 111 may be electrically connected to the negative electrode included in the first electrode assembly 110. The first negative electrode tab 111 may protrude in the first direction DR1.

The first positive electrode tab 112 may be provided on a second surface of the first electrode assembly 110. The first positive electrode tab 112 may be electrically connected to a positive electrode included in the first electrode assembly 110. The first positive electrode tab 112 may protrude in a direction opposite to the first direction DR1.

The second electrode assembly 120 may be adjacent to the first electrode assembly 110 in a second direction DR2. In an embodiment, the second electrode assembly 120 may be configured substantially the same as (or similar to) the first electrode assembly 110. For example, the second electrode assembly 120 may have a wound structure in which the negative electrode, the positive electrode, and the separator are wound. However, the present disclosure is not limited thereto. For example, the second electrode assembly 120 may have a stacking shape, a zigzag-folding shape, or a stack-folding shape.

The second electrode assembly 120 may include a second negative electrode tab 121 and a second positive electrode tab 122.

The second negative electrode tab 121 may be provided on a first surface of the second electrode assembly 120. The second negative electrode tab 121 may be electrically connected to a negative electrode included in the second electrode assembly 120. The second negative electrode tab 121 may protrude in the first direction DR1.

The second positive electrode tab 122 may be provided on a second surface of the second electrode assembly 120. The second positive electrode tab 122 may be electrically connected to a positive electrode included in the second electrode assembly 120. The second positive electrode tab 122 may protrude in a direction opposite to the first direction DR1.

The first current collector 210 may include a first projection CNP1 protruding in the first direction DR1. The first current collector 210 may be electrically connected to each of the first negative electrode tab 111 and the second negative electrode tab 121.

The second current collector 220 may include a second projection CNP2 protruding in a direction opposite to the first direction DR1. The second current collector 220 may be spaced apart from the first current collector 210. The second current collector 220 may be electrically connected to each of the first positive electrode tab 112 and the second positive electrode tab 122.

The first cap assembly 310 may include a first insertion hole H1 into which the first projection CNP1 is inserted. The second cap assembly 320 may include a second insertion hole H2 into which the second projection CNP2 is inserted.

The case 400 may accommodate the electrode assembly stacks 110, 120 and the current collectors 210, 220. In other words, the case 400 may include a receiving space for accommodating the electrode assembly stacks 110, 120 and the current collectors 210, 220.

The first surface and the second surface of the case 400 may be open, respectively. For example, the case 400 may include a first opening OPN1 corresponding to the first surface of the case 400 and a second opening OPN2 corresponding to the second surface of the case 400. Each of the first opening OPN1 and the second opening OPN2 may be extended to the receiving space. In this case, the first cap assembly 310 may cover the first surface of the case 400, and the second cap assembly 320 may cover the second surface of the case 400.

The battery cell 1 of the present disclosure may have a symmetrical shape with respect to a reference plane. The reference plane is a plane defined by the second direction DR2 and the third direction DR3, and may be a plane passing through the center of the electrode assembly stacks 110, 120. Therefore, hereinafter, among the components shown in FIGS. 1 to 3, only those disposed on the right side with respect to the reference plane will be described, and redundant descriptions of the components disposed on the left side will be omitted.

‘A first negative electrode tab 111’ and ‘a second negative electrode tabs 121’ may be referred to as ‘first electrode tabs 111, 121’, and ‘a first positive electrode tab 112’ and ‘a second positive electrode tab 122’ may be referred to as ‘second electrode tabs 112, 122’. Since the second electrode tabs 112, 122 may have a shape symmetrical to the first electrode tabs 111, 121 with the electrode assembly stacks 110, 120 interposed therebetween, the following description for the first electrode tabs 111, 121 may be applied substantially the same as (or similar to) the second electrode tabs 112, 122. Therefore, redundant descriptions of the second electrode tabs 112, 122 may be omitted.

The current collectors 210, 220 will be described based on the first current collector 210 disposed on the right side with respect to the reference plane. Since the second current collector 220 may have a shape symmetrical to the first current collector 210 with the electrode assembly stacks 110, 120 interposed therebetween, the following description of the first current collector 210 may be applied substantially the same as (or similar to) the second current collector 220. Therefore, redundant descriptions of the second current collector 220 may be omitted. Hereinafter, ‘the first current collector 210’ and ‘the first projection CNP1’ may be referred to as ‘the current collector 210’ and ‘the projection CNP1’.

The cap assemblies 310, 320 will be described based on the first cap assembly 310 disposed on the right side with respect to the reference plane. Since the second cap assembly 320 may have a shape symmetrical to the first cap assembly 310 with the electrode assembly stacks 110, 120 interposed therebetween, the following description of the first cap assembly 310 may be applied substantially the same as (or similar to) the second cap assembly 320. Therefore, redundant descriptions of the second cap assembly 320 may be omitted. Hereinafter, ‘the first cap assembly 310’ may be referred to as ‘the cap assembly 310’.

As described above, the plurality of electrode assemblies 110, 120 may be stacked such that the first electrode tabs 111, 121 and the second electrode tabs 112, 122 are aligned with each other, respectively, to form the electrode assembly stacks 110, 120. In this case, the current collectors 210, 220 may be provided on a first surface and a second surface of the electrode assembly stacks 110, 120, respectively, and the first electrode tabs 111, 121 and the second electrode tabs 112, 122 may be bent to surround the current collectors 210, 220 in a direction toward the projections CNP1, CNP2.

In an embodiment, the first electrode tabs 111, 121 may include first electrode extensions 111A, 121A extending from a first surface of the electrode assembly stacks 110, 120, and first electrode bends 111B, 121B bent from the first electrode extensions 111A, 121A and electrically connected to the current collector 210. In this case, as described above, the second electrode tabs 112, 122 may have a shape symmetrical to the first electrode tabs 111, 121 with the electrode assembly stacks 110, 120 interposed therebetween. The first electrode extensions 111A, 121A may be a part of first non-coated portions of the negative electrode included in the electrode assembly stacks 110, 120. The first electrode bends 111B, 121B may be another part of the first non-coated portions and may correspond to a portion where the first non-coated portions are coupled to be electrically connected to each other. The first electrode bends 111B, 121B may extend from the first electrode extensions 111A, 121A.

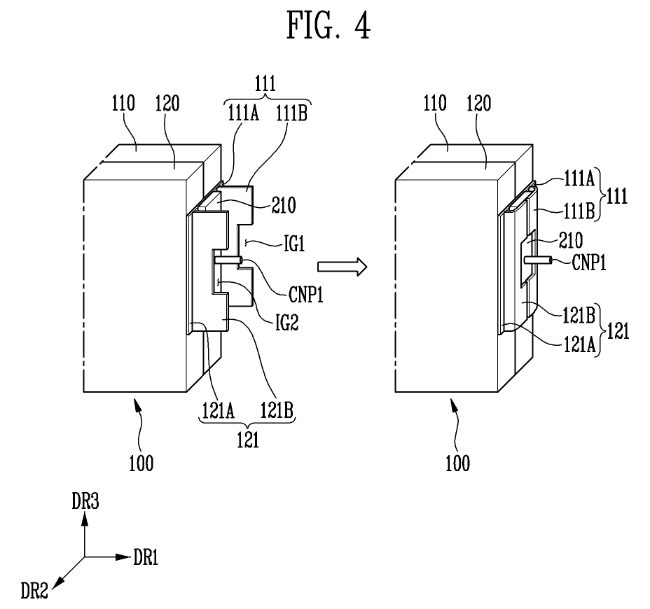

In an embodiment, the current collector 210 may be disposed between the first electrode tabs 111, 121. In this case, the first electrode bends 111B, 121B may be bent from the first electrode extensions 111A, 121A and electrically connected to the current collector 210. For example, the first electrode bends 111B, 121B may be bent in a direction toward the projection CNP1, and accordingly, the first electrode bends 111B, 121B may be electrically connected to the current collector 210. This will be described later with reference to FIG. 4.

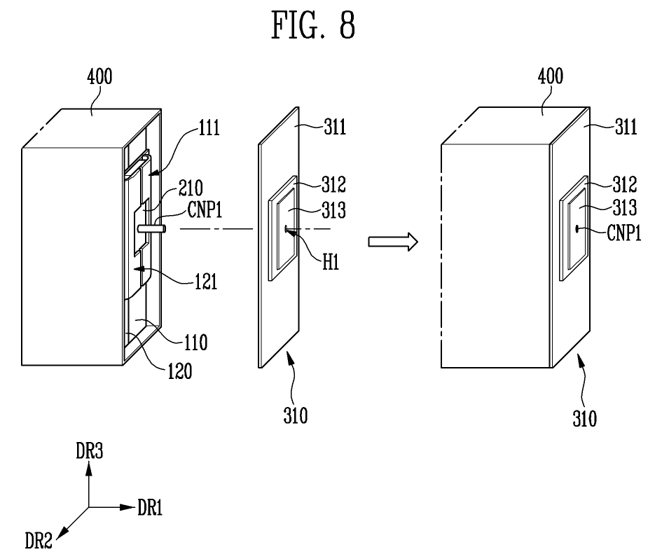

In an embodiment, the cap assembly 310 may include a cap plate 311, an insulating member 312, and a terminal 313. The cap assembly 310 including the cap plate 311, the insulating member 312, and the terminal 313 will be described later with reference to FIGS. 8 to 11.

FIG. 4 is a diagram to illustrate the electrical connection between the first electrode tabs and the current collector.

Referring to FIG. 4, the current collector 210 may be disposed between the first electrode tabs 111, 121, and each of the first electrode bends 111B, 121B may be bent in a direction toward the projection CNP1 to be electrically connected to the current collector 210.

In this case, each of the first electrode bends 111B, 121B may be spaced apart from the projection CNP1. Accordingly, the bending path for each of the first electrode bends 111B, 121B and the projection CNP1 may not interfere with each other. Therefore, the bending of each of the first electrode bends 111B, 121B may be effectively achieved, and the reliability of the electrical connection between the current collector 210 and the first electrode bends 111B, 121B may be improved.

To this end, in an embodiment, the first electrode bends 111B, 121B may include a first cut-out groove IG1 and a second cut-out groove IG2, respectively. Hereinafter, the first electrode bends 111B, 121B including the first cut-out groove IG1 and the second cut-out groove IG2 will be described.

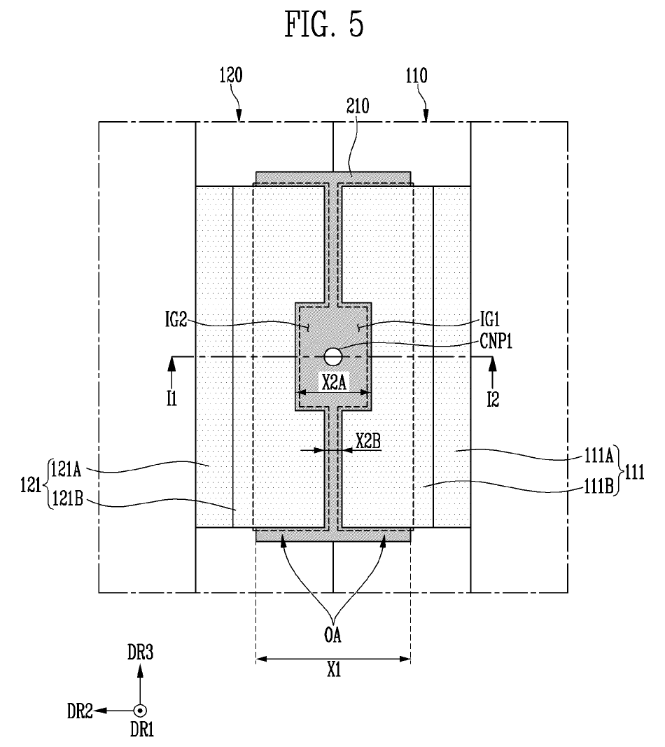

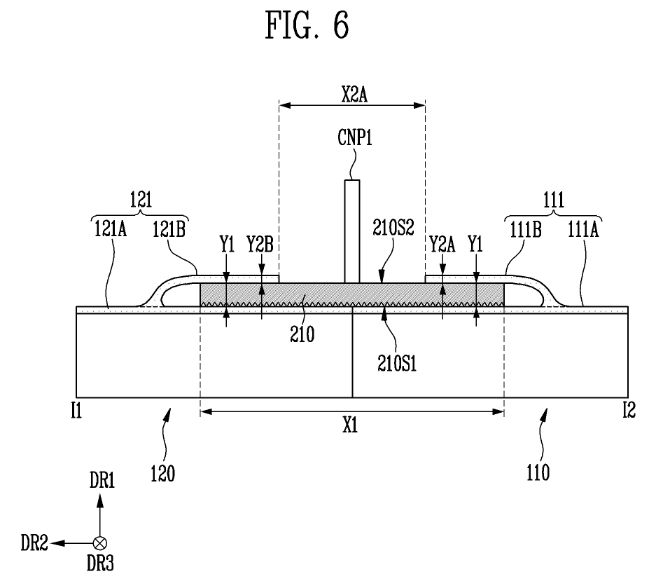

FIG. 5 is a diagram to illustrate a first electrode tab electrically connected to the current collector. FIG. 6 is a cross-sectional view to illustrate an embodiment of a cross-section cut along line I1-I2 of FIG. 5.

Referring to FIGS. 5 and 6, in an embodiment, the first electrode bends 111B, 121B may include a first cut-out groove IG1 and a second cut-out groove IG2, respectively, which are recessed in a direction away from the projection CNP1. As the first electrode bends 111B, 121B include the first cut-out groove IG1 and the second cut-out groove IG2, respectively, interference with the projection CNP1 upon bending of the first electrode bends 111B, 121B may be prevented. Therefore, the reliability of the electrical connection between the current collector 210 and the first electrode bends 111B, 121B may be improved.

In an embodiment, as shown in FIG. 5, the first cut-out groove IG1 and the second cut-out groove IG2 may surround the projection CNP1. In this case, the first cut-out groove IG1 and the second cut-out groove IG2 may have various shapes capable of preventing interference between the first electrode bends 111B, 121B and the projection CNP1. For example, although FIG. 5 shows an embodiment in which each of the first cut-out groove IG1 and the second cut-out groove IG2 is approximately rectangular, the present disclosure is not limited thereto. For example, each of the first cut-out groove IG1 and the second cut-out groove IG2 may be semi-circular.

In an embodiment, the first electrode bends 111B, 121B may be spaced apart from each other. Accordingly, interference with each other upon bending of the first electrode bends 111B, 121B may be prevented, thereby improving the reliability of the electrical connection between the current collector 210 and the first electrode bends 111B, 121B.

In an embodiment, a width X1 of the current collector 210 in a second direction DR2 may be greater than each of a minimum separation distance X2B in the second direction DR2 between the first electrode bends 111B, 121B and a maximum separation distance X2A in the second direction DR2 between the first electrode bends 111B, 121B. Accordingly, an area of a region where the first electrode bends 111B, 121B overlap the current collector 210 (hereinafter referred to as an overlapping area OA) may be sufficiently secured. The overlapping area OA may be a region to which a laser is irradiated during a welding process for electrically connecting the first electrode bends 111B, 121B to the current collector 210. As the area of the overlapping area OA is sufficiently secured, a sufficient process margin may be secured when irradiating the laser during the welding process. Therefore, manufacturing efficiency may be improved, and reliability of the battery cell 1 (see FIG. 1) may be enhanced.

In an embodiment, in the overlapping area OA, a thickness Y1 of the current collector 210 in the first direction DR1 may be greater than thicknesses Y2A, Y2B of the first electrode bends 111B, 121B in the first direction DR1. The overlapping area OA may be the area irradiated by the laser in the welding process, as described above. The laser may be directly irradiated onto the first electrode bends 111B, 121B having a relatively small thickness, such that the first electrode bends 111B, 121B may be electrically connected to the current collector 210. In this way, the efficiency of the welding process may be improved as the laser is directly irradiated on the first electrode bends 111B, 121B, which have a relatively small thickness and thus have a high heat transfer efficiency, and the first electrode bends 111B, 121B may be securely coupled to the current collector 210.

In such a case, as a thickness Y1 of the current collector 210 in the first direction DR1 is set to be relatively thick as described above, the current collector 210 may act as a barrier to shield the laser. Accordingly, with reference to FIG. 6, components disposed below the current collector 210 (i.e., components disposed in a direction opposite to the first direction DR1 relative to the current collector 210) may be prevented from being damaged by the laser. In other words, the reliability of the manufacturing process may be improved, and the reliability of the battery cell 1 (see FIG. 1) may be improved.

In an embodiment, the roughness of the first surface 210S1 of the current collector 210 adjacent to the electrode assembly stacks 110, 120 may be greater than the roughness of the second surface 210S2 of the current collector 210 opposite to the first surface 210S1. In such a case, the current collector 210 may be securely fixed in the preset position during the welding process, and thus, the reliability of the welding process may be improved.

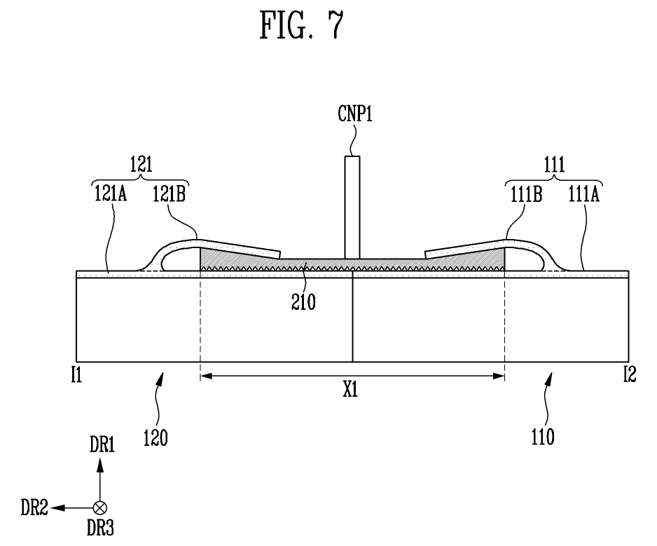

FIG. 7 is a cross-sectional view to illustrate another embodiment of a cross section cut along the line I1-I2 of FIG. 5. Hereinafter, the description will focus on the differences with respect to the embodiment described with reference to FIG. 6, and the descriptions of the omitted parts are replaced by the descriptions provided above.

Referring to FIG. 7, in the overlapping area OA (see FIG. 5), the thickness of the current collector 210 in the first direction DR1 may taper towards the projection CNP1. In such a case, the current collector 210 may have a shape corresponding to the bending shape of the first electrode bends 111B, 121B. Thus, the bending of the first electrode bends 111B, 121B may be more stable, and the first electrode bends 111B, 121B may be more securely coupled to the current collector 210.

FIG. 8 is a diagram to illustrate the coupling of the current collector and cap assembly.

Referring to FIG. 8, the cap assembly 310 may be coupled to the current collector 210 with the first electrode tabs 111, 121 electrically connected to the current collector 210. In this case, the projection CNP1 may be inserted into the insertion hole H1 of the cap assembly 310. Additionally, the cap assembly 310 may be coupled to the opening OPN1 (see FIG. 3) of the case 400, and may cover the opening OPN1 (see FIG. 3) of the case 400.

In an embodiment, the cap assembly 310 may include a cap plate 311, an insulating member 312, and a terminal 313.

The cap plate 311 may be coupled to the opening OPN1 (see FIG. 3) of the case 400. In an embodiment, the cap plate 311 may have a shape corresponding to the opening OPN1 (see FIG. 3) of the case 400, such that it may cover the opening OPN1 (see FIG. 3) of the case 400. For example, the cap plate 311 may have a plate shape, such as a rectangle, but the present disclosure is not limited thereto.

At least a portion of the insulating member 312 and the terminal 313 may protrude from the cap plate 311 in the first direction DR1.

The insulating member 312 may be coupled to the cap plate 311. For example, the insulating member 312 may be formed to be bonded to the cap plate 311 via an insert injection process. The insulating member 312 may include an insertion hole H1 into which the projections CNP1 are inserted. The insulating member 312 may surround at least a portion of the outer circumferential surface of the terminal 313. In an embodiment, the insulating member 312 may include a material having electrical insulating properties. In this case, the insulating member 312 may serve to prevent unnecessary electrical shorting caused by the terminal 313 coming into contact with other conductive components. In an embodiment, the insulating member 312 may be referred to as a ‘gasket’.

In an embodiment, the terminal 313 may include a material that is electrically conductive. In such a case, the terminal 313 may be electrically connected to the projection CNP1 inserted into the insertion hole H1 of the insulating member 312, and may function as an electrode terminal (e.g., a negative electrode terminal) of the battery cell 1 (see FIG. 1). In an embodiment, the insertion hole H1 may further penetrate the terminal 313, in which case at least a portion of the projections CNP1 inserted into the insertion hole H1 may be exposed outside of the terminal 313.

As previously described, the battery cell 1 (see FIG. 1) of the present disclosure may include: one or more electrode assemblies 110, 120 including first electrode tabs 111, 121 and second electrode tabs 112, 122 that are withdrawn in opposite directions from each other; one or more current collectors 210, 220 including projections CNP1, CNP2 that are electrically connected to the electrode assembly 110, 120; a case 400 including a receiving space for receiving the electrode assemblies 110, 120 and the current collector s 210, 220, and one or more openings OPN1, OPN2 extended to the receiving space and corresponding to the current collectors 210, 220; and one or more cap assemblies 310, 320 including cap plates 311, 321 coupled to the openings OPN1, ONP2, insulating members 312, 322 including insertion holes H1, H2 into which projections CNP1, CNP2 are inserted, and terminals 313, 323 electrically coupled to the projections CNP1, CNP2 inserted into the insertion holes H1, H2.

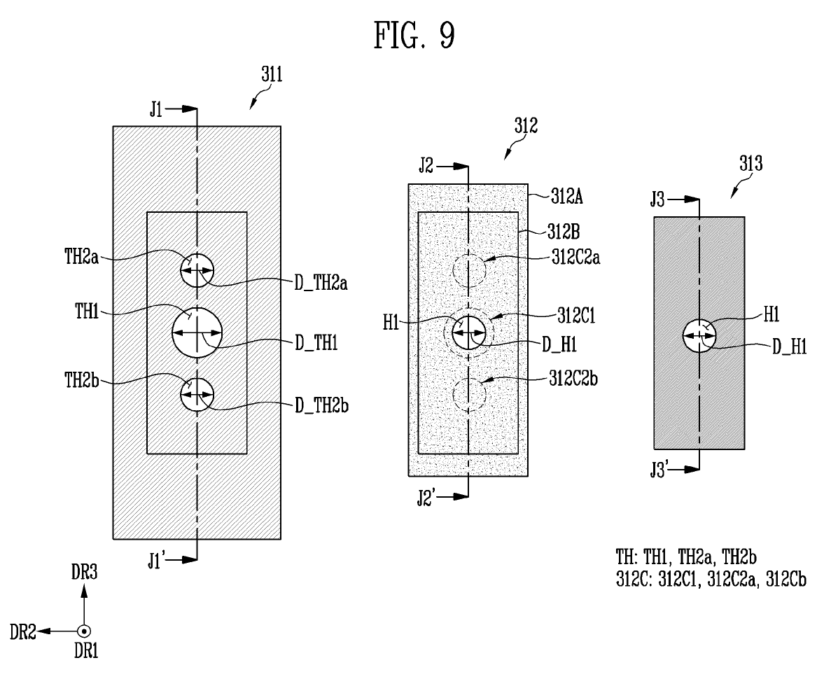

Hereinafter, the cap plate 311, insulating member 312, and terminal 313 will be described with reference to FIGS. 9 to 11.

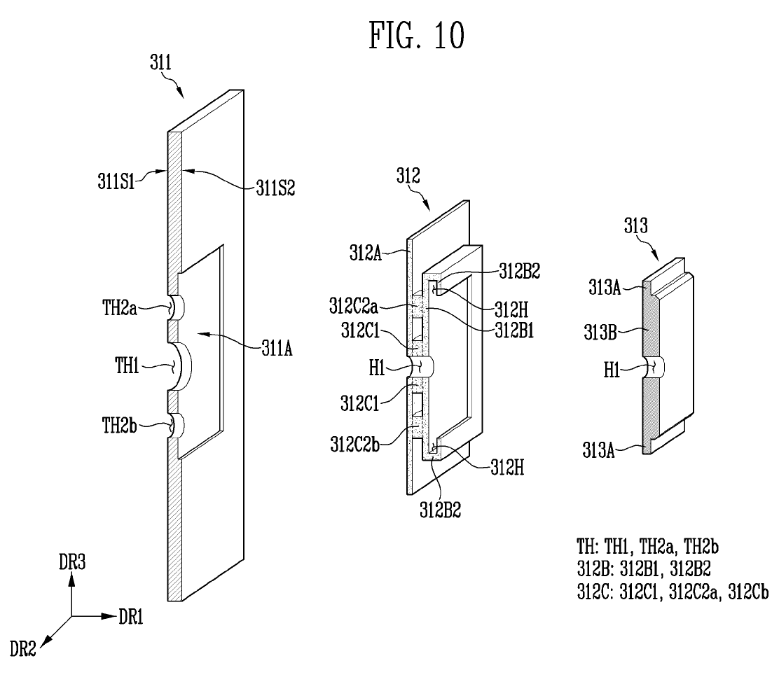

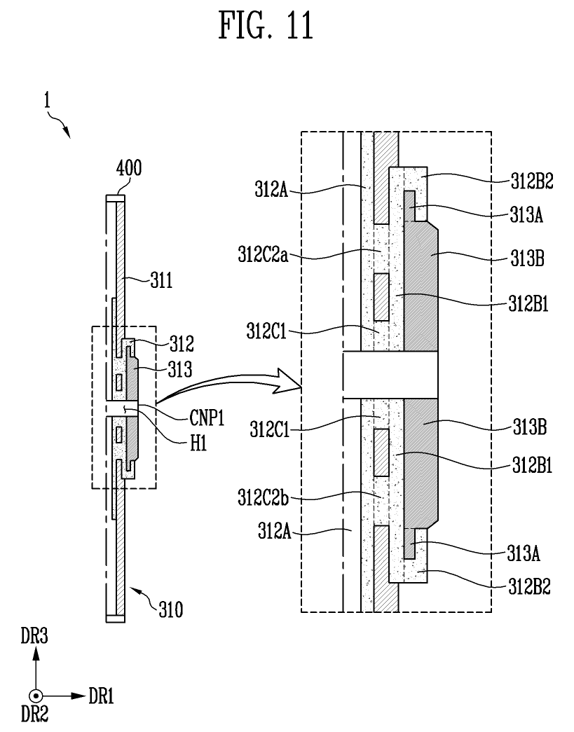

FIG. 9 is a plan view to illustrate a cap plate, insulating member, and terminal included in the cap assembly. FIG. 10 is a diagram to illustrate a cross-section of the cap plate, a cross-section of the insulating member, and a cross-section of the terminal included in the cap assembly. FIG. 11 is a schematic cross-sectional view of the battery cell to illustrate a state in which a projection is inserted into the insertion hole.

The line J1-J1' of FIG. 9 may be a line through the center of the cap plate 311, and the cap plate 311 may have a substantially symmetrical shape with respect to the line J1-J1'. In such a case, FIG. 10 shows a cross-sectional view of the cap plate 311 cut along the line J1-J1' of FIG. 9, and a portion of the cap plate 311 disposed to the right of the line J1-J1' relative to the view of FIG. 9.

Similarly, the line J2-J2' of FIG. 9 may be a line through the center of the insulating member 312, and the insulating member 312 may have a substantially symmetrical shape relative to the line J2-J2'. In such a case, FIG. 10 shows a cross-sectional view of the insulating member 312 cut along the line J2-J2' of FIG. 9, and a portion of the insulating member 312 disposed to the right of the line J2-J2' relative to the view of FIG. 9.

Similarly, the line J3-J3' of FIG. 9 may be a line through the center of the terminal 313, and the terminal 313 may have a substantially symmetrical shape relative to the line J3-J3'. In such a case, FIG. 10 shows the shape of a cross-section of the terminal 313 cut along the line J3-J3' of FIG. 9, and a portion of the terminal 313 disposed to the right of the line J3-J3' relative to the view of FIG. 9.

While FIGS. 9 and 10 separately illustrate the cap plate 311, insulating member 312, and terminal 313, the cap plate 311, insulating member 312, and terminal 313 may be arranged to be coupled to each other, as illustrated in FIG. 11.

Referring to FIGS. 9 to 11, the insulating member 312 and the cap plate 311 may be integrated by insert injection. For example, the insert injection described above may be performed using a resin for low-temperature, low-pressure molding (e.g., a polyamide resin and/or a polyolefin-based resin) and/or a resin for high-temperature, high-pressure molding (e.g., a polyethylene resin and/or an epoxy resin), and further, various other types of resins known in the art may be used as long as they are electrically insulating without adversely affecting the other components.

In an embodiment, the insulating member 312 may include a first support 312A disposed on a first surface 311S1 of the cap plate 311 adjacent to the electrode assemblies 110, 120 (see FIG. 8), a second support 312B disposed on a second surface 311S2 of the cap plate 311, and a connection 312C disposed between the first support 312A and the second support 312B to penetrate the cap plate 311. In such cases, the first support 312A, the second support 312B, and the connection 312C may be integrally formed.

As previously described, the insulating member 312 may be formed to be coupled to the cap plate 311 via an insert injection process. In such a case, the insulating member 312 may be securely coupled to the cap plate 311 as the connection 312C penetrates the cap plate 311, and the first support 312A and the second support 312B are disposed on the first surface 311S1 and the second surface 311S2 of the cap plate 311, respectively. Further, by providing the insulating member 312 directly coupled to the cap plate 311 without a separate coupling member, the number of parts required to manufacture the cap assembly 310 may be reduced.

In an embodiment, the cap plate 311 may include a through-hole TH through the cap plate 311. The connection 312C may be disposed within the through-hole TH and may have a shape corresponding to the through-hole TH.

In an embodiment, the through-hole TH may include a first through-hole TH1 and second through-holes TH2a, TH2b spaced apart from the first through-hole TH1. In such a case, the connection 312C may include a first connection 312C1 disposed within the first through-hole TH1 and second connections 312C2a, 312C2b disposed within the second through-holes TH2a, TH2b. In such a case, the insertion hole H1 may penetrate the first connection 312C1.

The first connection 312C1 may configure at least a portion of the insertion hole H1 for insertion of the projection CNP1. Further, the second connections 312C2a, 312C2b disposed within the second through holes TH2a, TH2b may serve to prevent flow of the insulating member 312 while the insulating member 312 is coupled to the cap plate 311, thereby allowing the insulating member 312 to be more securely coupled to the cap plate 311.

In an embodiment, a diameter D_TH1 of the first through-hole TH1 may be different from diameters D_TH2a, D_TH2b of the second through-holes TH2a, TH2b. For example, the diameter D_TH1 of the first through-hole TH1 in which the first connection 312C1 is disposed may be greater than the diameters D_TH2a, D_TH2b of the second through-holes TH2a, TH2b in which the second connections 312C2a, 312C2b are disposed, taking into account the margin when forming the insertion hole H1 in the first connection 312C1. In such a case, the diameter D_H1 of the insertion hole H1 may be smaller than the diameter D_TH1 of the first through-hole TH1.

In an embodiment, a plurality of second through-holes TH2a, TH2b may be provided, and a plurality of second connections 312C2a, 312C2b may be provided to each correspond to the second through-holes TH2a, TH2b. For example, the second through-holes TH2a, TH2b may include a second-first through-hole TH2a spaced apart from the first through-hole TH1 in a third direction DR3, and a second-second through-hole TH2b spaced apart from the first through-hole TH1 in a direction opposite to the third direction DR3. In such cases, the second connections 312C2a, 312C2b may include a second-first connection 312C2a disposed within the second-first through-hole TH2a, and a second-second connection 312C2b disposed within the second-second through-hole TH2b. However, the present disclosure is not limited to the foregoing examples. For example, the second through-hole and second connection each corresponding thereto may be provided by three or more. In such a case, flow of the insulating member 312 while the insulating member 312 is coupled to the cap plate 311 may be more effectively prevented, and the insulating member 312 may be more securely coupled to the cap plate 311.

In an embodiment, the height of the through-hole TH in the first direction DR1 may be the same as the height of the connection 312C in the first direction DR1, based on the direction (i.e., the first direction DR1) from the first support 312A toward the second support 312B. For example, the height of the first through-hole TH1 in the first direction DR1 may be the same as the height of the first connection 312C1 disposed within the first through-hole TH1 in the first direction DR1. The height of the second through-hole TH2a in the first direction DR1 may be the same as the height of the second -first connection 312C2a disposed within the second-first through-hole TH2a in the first direction DR1. The height of the second-second through-hole TH2b in the first direction DR1 may be the same as the height of the second-second connection 312C2b disposed within the second-second through-hole TH2b in the first direction DR1.

In an embodiment, the diameter of the through-hole TH may be the same as the diameter of the connection 312C. For example, the diameter D_TH1 of the first through-hole TH1 may be the same as the diameter of the first connection 312C1 disposed within the first through-hole TH1. The diameter D_TH2a of the second-first through-hole TH2a may be the same as the diameter of the second-first connection 312C2a disposed within the second-first through-hole TH2a. The diameter D_TH2b of the second-second through-hole TH2b may be the same as the diameter of the second-second connection 312C2b disposed within the second-second through-hole TH2b.

As described above, the connection 312C may have a shape corresponding to the through-hole TH. Accordingly, flow of the insulating member 312 while the insulating member 312 is coupled to the cap plate 311 may be more effectively prevented, and the insulating member 312 may be more securely coupled to the cap plate 311.

In an embodiment, the second support 312B may include a flat portion 312B1 disposed on the second surface 311S2 of the cap plate 311, and a bend 312B2 that is bent from an edge of the flat portion 312B1 to form a receiving groove 312H within a space from the flat portion 312B1. The flat portion 312B1 may be a portion coming in contact with the connection 312C, as shown in FIG. 10. In this case, the receiving groove 312H may be formed along the edge of the flat portion 312B1.

In an embodiment, the terminal 313 may include an edge 313A inserted into the receiving groove 312H, and a center 313B surrounded by the edge 313A. As the edge 313A is inserted into the receiving groove 312H, the terminal 313 may be coupled to the insulating member 312. As such, the terminal 313 and the insulating member 312 may be coupled without a separate coupling member, thereby reducing the number of parts required to manufacture the cap assembly 310.

In an embodiment, the thickness of the edge 313A in the first direction DR1 may be less than the thickness of the center 313B in the first direction DR1. In such a case, at least a portion of the center 313B may protrude in the first direction DR1 relative to the bend 312B2. The aforementioned protruding portion of the center 313B may function as an electrode terminal (e.g., a negative electrode terminal) of the battery cell 1. As such, as at least a portion of the center 313B protrudes in the first direction DR1 relative to the bend 312B2, the electrode terminals of the battery cell 1 may be easily identified when manufacturing a battery pack or the like utilizing the battery cell 1.

In an embodiment, the cap plate 311 may include a recess 311A that is recessed from the second surface 311S2 of the cap plate 311 to the first surface 311S1 of the cap plate 311. In such a case, the second support 312B may be disposed within the recess 311A. The recess 311A may have a shape corresponding to a portion of the second support 312B disposed within the recess 311A, and may thereby serve to securely fix the second support 312B. Furthermore, as the recess 311A is formed, the width of the battery cell 1 in the first direction DR1 may be reduced, thereby improving the spatial efficiency of the battery cell 1.

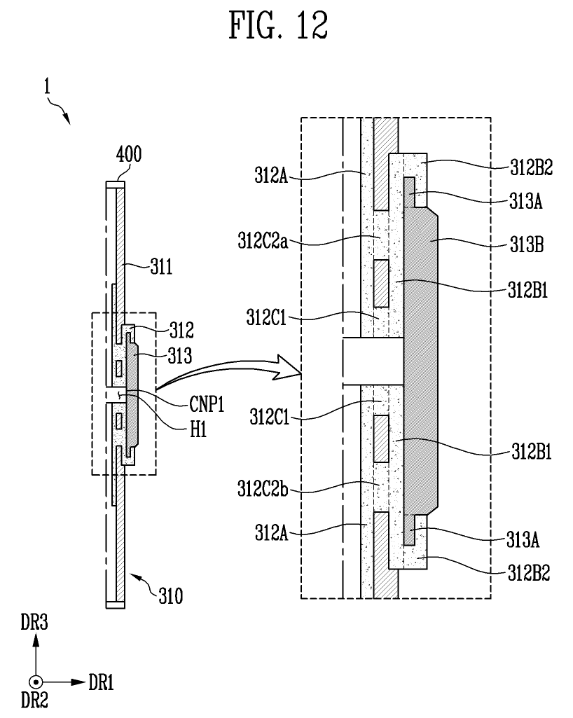

FIG. 12 is a schematic cross-sectional view illustrating a modified embodiment of FIG. 11. In the following, the description will focus on the differences with respect to the embodiment described with reference to FIGS. 9 to 11, and the descriptions of the omitted parts are replaced by the descriptions provided above.

Referring to FIG. 12, the insertion hole H1 may expose a surface of the terminal 313. In this case, the projections CNP1 inserted into the insertion hole H1 may be electrically connected (e.g., in direct contact) with the surface of the terminal 313. As such, the projections CNP1 may be covered by the terminal 313 and may not be exposed outside of the terminal 313.

The present disclosure may be practiced in various modifications, and the scope of the present disclosure is not limited to the embodiments set forth above. Therefore, in the case that a modified embodiment includes the components of the claims of the present disclosure, it should be regarded as falling within the scope of rights of the present disclosure.

What is claimed is:

1. A battery cell comprising:
a case including a receiving space receiving an electrode assembly and a current collector, and one or more openings extended to the receiving space and corresponding to the current collector; and
one or more cap assemblies including a cap plate coupled to the opening, an insulating member including an insertion hole into which the projection is inserted, and a terminal electrically connected to the projection inserted into the insertion hole,
wherein the insulating member and the cap plate are integrated by insert injection.

2. The battery cell according to claim 1, wherein the insulating member includes:
a first support disposed on a first surface of the cap plate adjacent to the electrode assembly;
a second support disposed on a second surface of the cap plate; and
a connection disposed between the first support and the second support to penetrate the cap plate.

3. The battery cell according to claim 2, wherein the first support, the second support, and the connection are integrated.

4. The battery cell according to claim 2, wherein the cap plate includes a through-hole through the cap plate,
wherein the connection is disposed within the through-hole and has a shape corresponding to the through-hole.

5. The battery cell according to claim 4, wherein the through-hole includes a first through-hole and a second through-hole spaced apart from the first through-hole,
wherein the connection includes a first connection disposed within the first through-hole, and a second connection disposed within the second through-hole.

6. The battery cell according to claim 5, wherein a diameter of the first through-hole is different from a diameter of the second through-hole.

7. The battery cell according to claim 5, wherein the insertion hole penetrates the first connection.

8. The battery cell according to claim 7, wherein a diameter of the insertion hole is smaller than the diameter of the first through-hole.

9. The battery cell according to claim 5, wherein a plurality of second through-holes are provided,
wherein the plurality of second connections are provided to correspond to each of the second through-holes.

10. The battery cell according to claim 2, wherein the second support includes:
a flat portion disposed on the second surface of the cap plate; and
a bend bent from an edge of the flat portion to form a receiving groove within a space from the flat portion.

11. The battery cell according to claim 10, wherein the terminal includes:
an edge inserted into the receiving groove; and
a center surrounded by the edge.

12. The battery cell according to claim 11, wherein a first direction is defined, which is a direction from the first support toward the second support,
wherein a thickness of the edge in the first direction is less than a thickness of the center in the first direction.

13. The battery cell according to claim 2, wherein the insertion hole exposes a surface of the terminal,
wherein the projection inserted into the insertion hole is electrically connected to the surface of the terminal.

14. The battery cell according to claim 2, wherein the insertion hole further penetrates the terminal,
wherein at least a portion of the projection inserted into the insertion hole is exposed outwardly of the terminal.

15. The battery cell according to claim 2, wherein the cap plate includes a recess recessed from the second surface of the cap plate to the first surface of the cap plate,
wherein the second support is disposed within the recess.

16. The battery cell according to claim 1, wherein a plurality of electrode assemblies are provided,
wherein each of the electrode assemblies includes a first electrode tab and a second electrode tab withdrawn in opposite directions from each other,
wherein the current collector includes a projection electrically connected to the electrode assembly,
wherein plurality of electrode assemblies are stacked such that the first electrode tab and the second electrode tab are aligned with each other, respectively, to form an electrode assembly stack,
the current collector is provided on a first surface and a second surface of the electrode assembly stack, respectively, and
the first electrode tab and the second electrode tab are bent to surround the current collector in a direction toward the projection.

17. The battery cell according to claim 16, wherein the first electrode tab includes a first electrode extension extending from a first surface of the electrode assembly stack, and a first electrode bend bent from the first electrode extension and electrically connected to the current collector,
wherein the second electrode tab has a shape symmetrical to the first electrode tab with the electrode assembly stack interposed therebetween.

18. The battery cell according to claim 17, wherein, in an overlapping area where the first electrode bend and the current collector overlap, a thickness of the current collector is greater than a thickness of the first electrode bend.

19. The battery cell according to claim 18, wherein, in the overlapping area, a thickness of the current collector tapers in a direction toward the projection.

20. The battery cell according to claim 17, wherein a roughness of a first surface of the current collector adjacent to the electrode assembly stack is greater than a roughness of a second surface opposite the first surface of the current collector.
